(19) United States
(12) Patent Application Publication
(10) Pub. No.: US 2004/0249105 A1
(43) Pub. Date: Dec. 9, 2004

(54) Process and apparatus for the production of a two-component coating mixture

(76) Inventors: Hans-Jurgen Nolte, Besigheim (DE); Harry Krumma, Bonnigheim (DE); Frank Herre, Oberriexingen (DE); Bernd Klinksiek, Bergisch Gladbach (DE); Lars Obendorf, Koln (DE); Nusret Yuva, Wermelskirchen (DE); Markus Mechtel, Bergisch Gladbach (DE)

Correspondence Address: BAYER MATERIAL SCIENCE LLC, 100 BAYER ROAD, PITTSBURGH, PA, 15205, US

(21) Appl. No.: 10/789,026

(22) Filed: Feb. 25, 2004

(30) Foreign Application Priority Data
Feb. 28, 2003 (DE) 10308755.9
May 21, 2003 (DE) 10322998.1

(51) Int. Cl. C08G 18/00; C08G 18/28; C08G 18/77; B01F 15/02

(52) U.S. Cl. 528/44; 366/136; 366/162.4

(57) ABSTRACT

The invention relates to an apparatus for the production of a two-component coating mixture, in particular for the production of a an aqueous two-component polyurethane coating emulsion from an aqueous binder dispersion comprising isocyanate-reactive hydrogen atoms and a polyisocyanate, with a mixer for the production of the two-component coating mixture by mixing a first coating component and a second coating component and with a homogeniser for homogenisation of the two-component coating mixture, the homogeniser being downstream from the mixer. It is proposed that, in the outlet zone of the homogeniser, a return line branches off, which opens into the inlet zone of the homogeniser, in order to recirculate a portion of the two-component coating mixture homogenised by the homogeniser for rehomogenisation. The invention furthermore comprises a corresponding process and a substrate which is coated with a coating produced in corresponding manner.

### CROSS REFERENCE TO RELATED PATENT APPLICATION

The present patent application claims the right of priority under 35 U.S.C. §119 (a)-(d) of German Patent Application No.103 08 755.9, filed Feb. 28, 2003 and of German Patent Application No. 103 22 998.1, filed May 21, 2003

### FIELD OF THE INVENTION

The invention relates to a process for the production of a two-component coating mixture, in particular for the production of aqueous two-component polyurethane coating emulsions.

### BACKGROUND OF THE INVENTION

Two-component polyurethane coatings (two-pack PU coatings) have a limited pot life (period during which they may be applied), when the two components of the coatings are mixed only shortly before application. Depending upon the reactivity of the coating systems, pot life may range from several minutes to hours.

While such two-component systems have in the past been used as solutions in organic solvents, many water-dispersible two-component systems have been developed in more recent times. Water-dispersible two-component systems generally consist of a resin component (binder, polyol) comprising hydroxyl groups and a polyisocyanate component (curing agent, crosslinking agent). The hydroxy-functional resin component is here generally present as an aqueous dispersion, while the polyisocyanate component is present as an anhydrous, 100% component or as a solution in a solvent. Such systems, which may also be used for the purposes of the present invention, are disclosed, for example, in EP-A 358 979, 496 205, 469 389, 520 266, 540 985, 542 105, 543 228, 548 669, 562 282 and 583 728. The disadvantage of these coating systems is that, in some applications, they do not yet achieve the coating quality obtained with two-component systems based on purely organic solvents. This especially applies to applications in which there are particularly stringent requirements with regard to optical properties and resistance.

It is known that high quality coating surfaces can be obtained with coating dispersions having the smallest possible particle sizes. The polyol dispersions used in aqueous two-component polyurethane coatings are thus those with a sufficiently small particle size of less than 500 nm, preferably of 10-200 nm. The intrinsically hydrophobic isocyanate component is dispersed shortly before application of the coatings, as the polyisocyanate component reacts with water and accordingly has only limited storage stability in the presence of water.

Polyisocyanates have also been developed which are either hydrophilised by chemical modification or contain external emulsifiers. While these may indeed be dispersed to an average particle size of below 1000 nm distinctly more straightforwardly with static mixers, the cured coating films only exhibit resistance which is inadequate for many applications. In contrast, coating films with good resistance are obtained by using hydrophobic polyisocyanate components.

In the light of the fact that the dispersibility of the isocyanate component is limited by the stabilisation reaction which proceeds on the surface of pre-existing particles, it is essential to achieve the most finely divided dispersion possible as rapidly as possible. Dispersion must accordingly proceed within a period of time which is sufficiently short for no appreciable surface stabilisation yet to have occurred. In particular, heating should also be avoided during dispersion as this accelerates the reaction of the polyisocyanate component with water.

EP-B 0 685 544 discloses a process for the production of aqueous two-component polyurethane coating emulsions based on binder resins comprising isocyanate-reactive hydrogen atoms and polyisocyanates by mixing the components with water. In continuous operation, a polyol/water dispersion on the one hand and a polyisocyanate on the other are supplied to a jet disperser for dispersion. Homogenisation pressures of approx. 5 MPa are required in order to obtain a finely divided emulsion of the polyisocyanate with a particle size of approx. 0.5 μm in the aqueous polyol emulsion with a particle size of approx. 0.2 μm. The isocyanate particles are stabilised by the ionically-modified polyol particles. No emulsifier is necessary.

DE-A 19 933 441 furthermore discloses a process for the production of aqueous two-component polyurethane coating emulsions based on aqueous binder dispersions comprising isocyanate-reactive groups and polyisocyanates by mixing the two components at a pressure of 1 to 30 MPa in an adjustable jet disperser with openable or closable nozzle bores or slots according to DE-A 19 933 440. In said process, a pre-emulsion is initially produced at a relatively low pressure of, for example, 0.1 MPa. Homogenisation then proceeds in an adjustable jet disperser at a pressure of 1 to 30 MPa. Either a certain number of bores or a certain slot length are opened by adjusting the feedback-controlled control piston with a pneumatic cylinder. In this manner, constantly good dispersion quality is achieved with a continuously variable throughput of material to be dispersed. However, DE-A 19 933 441 provides no information about the throughput of material to be dispersed at which a constantly finely divided dispersion is obtained. DE-A 19 933 441 moreover discloses, by way of example, an embodiment for automotive original coating.

In modern coating facilities, for example in automotive original coating, the clear coat is increasingly applied electrostatically by means of robots. On application of the coating, the atomising bell is passed over the automotive body by a robot arm. In order to minimise long piping runs and the associated large volumes of rinsings and waste, it is advantageous for the polyisocyanate to be emulsified into the aqueous polyol component continuously immediately prior to introduction into the atomising bell on the robot arm. If this is to be achieved, both the dispersion nozzle and the pumps required for conveying and pressurisation must be sufficiently small and light for it to be possible to integrate them into the robots. In automotive original coating, gear pumps are accordingly preferred for clear coat application.

Within the clear coat viscosity range conventional in automotive original coating and at conventional intake rates, today's conventional gear pumps can sensibly be used up to a delivery pressure of at most 2.5 MPa. Due to the geometry of an automotive body, the intake rate of an atomising bell varies within very short intervals of time, such that it must be possible to control the intake rate of the material to be dispersed correspondingly rapidly. Typical atomising bell intake rates in automotive original coating are in the range from 50 to 400 g/min. One disadvantage of known dispersion apparatuses and dispersion processes is the relatively high pressure required for the production of finely divided emulsions. According to DE-A 19 933 440, the two pumps for delivery of the binder component and of the curing agent generate the differential pressure required both for the upstream mixing nozzle and for the adjustable homogenising nozzle. A differential pressure of 5 MPa is stated for the adjustable dispersion apparatus. Gear pumps are accordingly unsuitable for such a dispersion pressure. Other pumps, such as for example diaphragm piston pumps must be arranged externally due to their size and weight and suffer the above-stated disadvantages.

Another disadvantage of the known process is that there is a distinct reduction in dispersion quality at low throughputs for a complete installation with two or more atomising bells of the order of 400 to 500 g/min, such that the elevated requirements for optical properties, as are necessary in automotive coating, are not achieved.

A further unfavourable feature of the dispersion apparatus described in DE-A 19 933 441 is that it preferably consists of a ceramic sleeve with homogenising bores and a ceramic piston arranged displaceably in the chamber. The ceramic components must be ground to a very accurate fit in order to avoid leakage between the piston and sleeve. A dispersion apparatus which does not require movable components which are ground to a good fit would be advantageous.

On the basis of the above-described disadvantages of known dispersion processes and apparatuses, robot application of aqueous two-component polyurethane coating emulsions can only be achieved with major disadvantages or not at all.

The object of the present invention is accordingly to provide a process for the production of an aqueous two-component polyurethane coating emulsion from an aqueous binder dispersion comprising isocyanate-reactive hydrogen atoms and a polyisocyanate by emulsifying the polyisocyanate and the binder dispersion, which process does not exhibit the above-stated disadvantages. The process should produce a finely divided emulsion at relatively low dispersion pressures and at a relatively low throughput of the material to be dispersed.

A further object of the invention is to provide an apparatus for the production of an aqueous two-component polyurethane coating emulsion from an aqueous binder dispersion comprising isocyanate-reactive hydrogen atoms and a polyisocyanate by emulsifying the polyisocyanate and the binder dispersion, which apparatus produces constantly good emulsion quality at relatively low dispersion pressures and at a relatively low throughput of the material to be dispersed.

### SUMMARY OF THE INVENTION

The present invention is directed to a process for producing a two-component coating mixture including:

mixing a first coating component and a second coating component in a mixer to yield the two-component coating mixture, and

homogenizing the two-component coating mixture using a homogeniser.

At least a portion of the two-component coating mixture is homogenised repeatedly in succession in the homogeniser. The invention is further directed to substrates coated using the above-described method.

The present invention is also directed to an apparatus for the production of a two-component coating mixture. The apparatus includes a mixer for the production of the two-component coating mixture capable of mixing a first coating component and second component, and a homogeniser capable of homogeniser capable of homogenizing the two-component coating mixture, the homogeniser being arranged downstream from the mixer, where a return line, which branches off in an output zone of the homogeniser and opens into an input zone of the homogeniser, in order to recirculate a portion of the two-component coating mixture homogenised by the homogeniser for rehomogenisation.

### DESCRIPTION OF THE DRAWINGS

FIG. 1 is a schematic diagram of the apparatus according to the invention;

FIG. 2 shows a cross-sectional view of the mixer of the apparatus from FIG. 1 for the production of the pre-emulsion by the process according to the invention;

FIG. 3 shows a cross-sectional view of the homogeniser of the apparatus from FIG. 1 in the form of a jet disperser for the production of the coating emulsion by the process according to the invention;

FIG. 4 shows a cross-sectional view of an alternative exemplary embodiment of the mixer in FIG. 1;

FIG. 5 shows a cross-sectional vies of an alternative exemplary embodiment of the homogeniser in FIG. 1;

FIG. 6 shows a cross-sectional view of a modified apparatus according to the invention;

FIG. 7 shows a schematic diagram of an alternative exemplary embodiment of the apparatus according to the invention; and

FIG. 8 shows a cross-sectional view of an alternative exemplary embodiment of the mixer in FIG. 1.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The invention relates to a process for the production of a two-component coating mixture, in particular for the production of aqueous two-component polyurethane coating emulsions from an aqueous binder dispersion comprising isocyanate-reactive hydrogen atoms and a polyisocyanate by mixing the polyisocyanate and the binder dispersion. The invention furthermore relates to an apparatus for performing the process and to a substrate which is coated with a coating which has been produced in accordance with the process according to the invention. The present process and apparatus have been found to achieve the object of the invention.

The present invention accordingly provides a process for the production of a two-component coating mixture and in particular an aqueous two-component polyurethane coating emulsion from an aqueous binder dispersion comprising isocyanate-reactive hydrogen atoms and a polyisocyanate by mixing the polyisocyanate and the binder dispersion, wherein the following steps are preferably carried out:

a) mixing of a first coating component and a second coating component in a mixer to yield the two-component coating mixture,

b) homogenisation of the two-component coating mixture by a homogeniser, wherein the two-component coating mixture is at least in part homogenised repeatedly in succession.

The first coating component preferably comprises an aqueous binder dispersion comprising isocyanate-reactive hydrogen atoms, while the second coating component preferably contains polyisocyanate. The invention is not, however, restricted to these specific coating components, but may also be performed with other coating components. For simplicity's sake, however, the invention is hereinafter described on the basis of the above-mentioned preferred coating components.

For the purposes of the invention, it is, for example, also possible to use any binders and crosslinking components hitherto used for two-component polyurethane coatings, as are known, for example, from EP-A 358 979, EP 496 205, EP 469 389, EP 520 266, EP 540 985, EP 542 105, EP 543 228, EP 548 669, EP 562 282 and EP 583 728.

Compounds suitable as an aqueous binder dispersion comprising isocyanate-reactive hydrogen atoms are, for example, polyacrylates, polyesters, urethane-modified polyesters, polyethers, polycarbonates or polyurethanes comprising isocyanate-reactive groups, in particular those with a molecular weight range of 1000 to 10000 g/mol. Hydroxyl groups are preferably used as the isocyanate-reactive groups. The binder resins are used as aqueous dispersions.

Any desired organic polyisocyanates with aliphatically, cycloaliphatically, araliphatically and/or aromatically attached free isocyanate groups are suitable as the polyisocyanate component. The polyisocyanate component should in general have a viscosity of 20 to 1000 mPa.s, preferably of below 500 mPa.s. Higher viscosity polyisocyanates may, however, also be used if the viscosity of the polyisocyanate component is reduced by an appropriate solvent content.

The polyisocyanates used are particularly preferably those having exclusively aliphatically and/or cycloaliphatically attached isocyanate groups with an average NCO functionality of between 2.2 and 5.0 and a viscosity of 50 to 500 mPa.s at 23° C. At a correspondingly low viscosity, it is possible according to the invention to obtain a dispersion with a sufficiently small particle size completely without addition of solvent.

The conventional additives and modifiers known in coatings chemistry may furthermore be used.

Repeated homogenisation of the two-component coating mixture is preferably achieved by recirculating a portion of the homogenised two-component coating mixture from the homogeniser outlet to the homogeniser inlet via a return line. The recirculated portion of the two-component coating mixture thus passes through the homogeniser repeatedly, so distinctly increasing the degree of homogenisation of the two-component coating mixture at the homogeniser outlet. The two-component coating mixture preferably passes through the homogeniser at least twice, but substantially larger numbers of passes are also possible for the purposes of the invention.

The mixer preferably takes the form of a mixing nozzle, a flat jet nozzle for example being suitable. It is furthermore possible to use a mixing nozzle which functions in a similar manner to pre-emulsification in the jet disperser known from DE 19 510 651. However, with regard to the design of the mixer, the invention is not restricted to a mixing nozzle, but may also be performed in another manner. The homogeniser, on the other hand, preferably takes the form of a jet disperser in which the two-component coating mixture is homogenised by the shear forces which arise. The jet disperser known from DE 19 510 651 may, for example, be used as the jet disperser. However, with regard to the design of the homogeniser, the invention is not restricted to a jet disperser, but may also be performed in another manner. Slot nozzles, annular slot nozzles or hole-type nozzles may alternatively also be used.

The two coating components are supplied to the mixer, preferably separately by a respective pump, the maximum pressure preferably being 2.5 MPa.

A further pump, arranged between the mixer and homogeniser, is preferably also provided, said pump preferably having a greater delivery capacity than both the pumps for supplying the two coating components to the mixer together. This is advantageous because the pump between the mixer and homogeniser is supplied not only by the mixer, but also delivers a portion of the two-component coating mixture from the homogeniser outlet via the return line.

According to step a) of the process according to the invention the aqueous binder dispersion comprising isocyanate-reactive hydrogen atoms and the polyisocyanate are thus supplied, preferably separately from one another by a respective pump, to a mixing nozzle to produce the pre-emulsion. The pressure of each of these pumps is preferably at most 2.5 MPa, preferably from 0.001 to 2 MPa. The low pressure makes it possible to select types of pump which are of relatively small dimensions. In a preferred embodiment of the process according to the invention, the pumps are gear pumps. These are relatively small and light, such that they can be accommodated in a coating installation robot arm.

According to step b) of the process according to the invention, the pre-emulsion is homogenised, preferably in a homogenising nozzle, likewise at a pressure of at most 2.5 MPa, preferably of 0.001 to 2 MPa, the pre-emulsion preferably being supplied to the homogenising nozzle with a further pump which is connected downstream from the mixing nozzle. Due to the low pressure, it is possible in this case too to select types of pump which are of relatively small dimensions. In a preferred embodiment of the process according to the invention, the pump is accordingly likewise a gear pump. Since said pump is relatively small and light, it can be accommodated in a coating installation robot arm. Accordingly, in a preferred embodiment of the process, the apparatus required to produce the coating emulsion, which consists at least of a mixing nozzle, a homogenising nozzle and three pumps, may be arranged on an application device, such as for example a robot or robot arm. This has the advantage that shorter feed lines are required and rinsing of the apparatus is simpler than in processes known from the prior art.

The delivery rate of the pump connected downstream from the mixing nozzle is preferably greater than the sum of the delivery rates of the pumps with which the binder dispersion and polyisocyanate are supplied to the mixing nozzle. If the dispensed quantity of coating emulsion is lower than the volumetric flow rate of the pump connected downstream from the mixing nozzle, the excess amount of coating emulsion is recirculated. The lower the volumetric flow rate of the pre-emulsion, i.e. the lower the delivery rate of the pumps which supply the binder dispersion and polyisocyanate to the mixing nozzle, the more frequently is the coating emulsion recirculated and rehomogenised in the homogenising nozzle. Since low volumetric flow rates of the pre-emulsion and low pressures give rise to relatively coarse coating emulsions, it is possible in this manner to obtain finely divided coating emulsions by repeated homogenisation. Repeated homogenisation of the pre-emulsion modifies the particle size frequency distribution. The frequency distribution becomes narrower as the fraction at the coarse end of the particle size range is shifted towards smaller particle sizes. The volumetric flow rate of the pre-emulsion is preferably from 50 to 3000 g/min. Finely divided coating emulsions are obtained at these volumetric flow rates. The volumetric flow rate of the pre-emulsion may be substantially constant or be discontinuously or continuously variable. The range over which the volumetric flow rate is continuously variable while nevertheless resulting in the formation of a constantly finely divided emulsion depends inter alia on nozzle geometry. Another advantage of the process according to the invention or of the apparatus according to the invention is that the dispensed quantity of coating emulsion can be varied without requiring the use of movable or displaceable components, for example a piston displaceable in a sleeve as a jet disperser. This reduces the level of maintenance required for the apparatus according to the invention relative to apparatuses known from the prior art.

The process according to the invention, which consists at least of production of the pre-emulsion (step a) and homogenisation of the pre-emulsion (step b), may also be performed not continuously, but instead batchwise in two separate steps. After emerging from the homogenising nozzle, the coating emulsion obtained by the process according to the invention is supplied as immediately as possible to a suitable dispensing apparatus, for example an atomising nozzle. The process according to the invention has the advantage that, even at a relatively low throughput of the material to be dispersed of 50 g/min to 3000 g/min and relatively low pressures of at most 2.5 MPa, finely divided coating emulsions with a frequency distribution d₉₀ of at most 2.5 μm are obtained.

The emulsion obtained by the process according to the invention is suitable for the production of high quality coatings on the most varied substrates and materials, such as wood, metals, plastics etc. The coating systems are preferably used for original coating of automotive bodies or body parts.

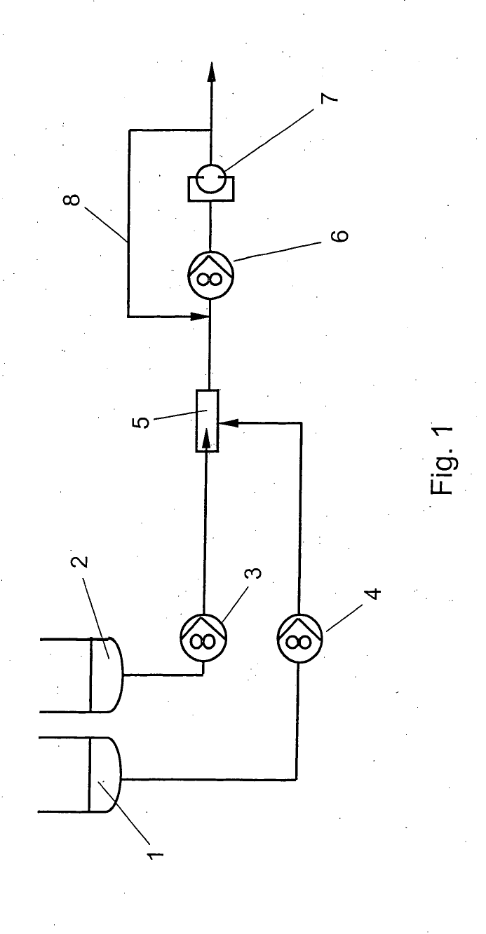

The schematic diagram in FIG. 1 shows two storage tanks for an aqueous binder dispersion comprising isocyanate-reactive hydrogen atoms 1 and for a polyisocyanate 2.

The two storage tanks are connected via separate feed lines and a respective metering pump 3, 4 with a mixer 5 taking the form of a mixing nozzle, which mixes the binder dispersion 1 with the polyisocyanate 2 and forms a pre-emulsion. Metering gear pumps or piston metering pumps are preferably used as the metering pumps 3, 4.

The pre-emulsion is homogenised by being drawn in by a pump 6 and supplied to a homogeniser 7 taking the form of a homogenising nozzle. The pump 6 is, for example, a gear pump or a piston metering pump.

The delivery rate of the pump 6 is greater than the sum of the delivery rates of metering pumps 3 and 4. Since the quantity of coating emulsion dispensed is less than the delivery rate of the pump 6, a return line 8 compensates the disparity by recirculating the undispensed quantity of coating emulsion to the homogeniser 7. The lower the delivery rate of the metering pumps 3 and 4, i.e. the lower the volumetric flow rate of the pre-emulsion, the more frequently on average is the emulsion circulated and thus repeatedly homogenised. Since coarser pre-emulsions are obtained at lower delivery rates, high intensity post-homogenisation is achieved in this manner.

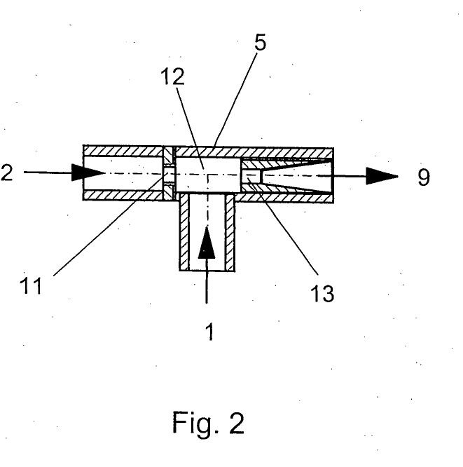

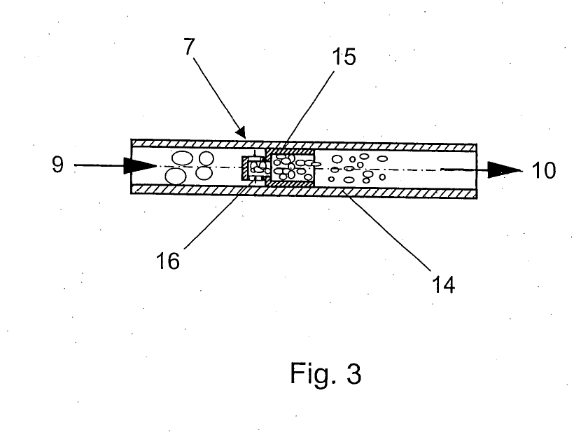

FIG. 2 shows an embodiment of the mixer 5, as is used to produce a pre-emulsion 9 according to step a) of the process according to the invention. In the mixer 5, the polyisocyanate 2 is forced via a nozzle bore 11 into a premixing chamber 12 into the binder dispersion 1 comprising isocyanate-reactive hydrogen atoms, for example a polyol. The polyisocyanate 2 and the binder dispersion 1 are together forced through a nozzle bore 13 so resulting in the formation of a pre-emulsion 9. The binder dispersion 1 comprising isocyanate-reactive hydrogen atoms may conversely also be forced into the polyisocyanate 2 in the mixer 5. According to FIG. 3, the pre-emulsion 9 enters the homogeniser 7, which takes the form of a jet disperser and consists of a tube and an insert 16 with lateral nozzle bores. The pre-emulsion 9 is forced through the nozzle bores. The coating emulsion 10 emerges from the jet disperser 7 at the opposite end. Such a jet disperser is known from DE 195 10 651. Jet dispersers functioning in accordance with a similar principle may also be used.

### EXAMPLES

The following formulation of the aqueous binder dispersion comprising isocyanate-reactive hydrogen atoms is selected for the exemplary embodiments and the Comparative Examples:

29.7 wt. % of an OH-functional polyacrylate dispersion with a non-volatile content (DIN EN ISO 3251) of approx. 46 wt. %, a viscosity (23° C., DIN EN ISO 3219) of at most 1500 mPa.s and an OH content, relative to solid resin, of 4.5 wt. %

29.7 wt. % of an OH-functional polyurethane dispersion with a non-volatile content (DIN EN ISO 3251) of approx. 45 wt. %, a viscosity (23° C., DIN EN ISO 3219) of at most 1200 mPa.s and an OH content, relative to solid resin, of 3.8 wt. %

0.3 wt. % of Byk® 345 (Byk Chemie GmbH, Germany)

0.3 wt. % a 25 wt. % aqueous solution of Byk® 333 (Byk Chemie GmbH)

9.4 wt. % of distilled water.

The following formulation is selected as the polyisocyanate:

18.7 wt. % of a polyisocyanate containing isocyanurate groups based on 1,6-diisocyanatohexane (HDI) with an NCO content of 23.2%, an average NCO-functionality of 3.2 (according to gel permeation chromatography), a content of monomeric HDI of less than 0.25% and a viscosity of 1200 mPa.s (23° C.)

1.8 wt. % of Tinuvin® 1130 (Ciba Spezialitätenchemie GmbH, Germany), 50% in Rhodiasolv® RP DE (Brenntag GmbH, Germany)

0.9 wt. % of a 50 wt. % solution of Tinuvin® 292 (Ciba

Spezialitätenchemie GmbH) in Rhodiasolv RP DE

9.2 wt. % of cosolvent Rhodiasolv RP DE.

### Example 1 (Exemplary Embodiment)

The metering pumps 3 and 4 (see FIG. 1), which take the form of metering gear pumps, are adjusted such that a ratio by weight of polyol component 1 to polyisocyanate component 2 of 2.28:1 is established. The volumetric flow rates of the metering pumps 3 and 4 were varied over the range from 200 to 800 g/min, while pump 6, which takes the form of a gear pump, was adjusted to a volumetric flow rate which was greater than the total of volumetric flow rates of metering pumps 3 and 4. The mixer 5 comprised a nozzle bore 11 of 0.4 mm and a nozzle bore 13 of 0.6 mm. The jet disperser 7 was equipped with two nozzle bores 16 each of 0.6 mm.

The aqueous two-component polyurethane dispersions produced in this manner were used in the following investigations to evaluate dispersion and coating quality:

Test A: A film of the coating emulsion was deposited on a glass sheet to a wet film thickness of 90 μm. Transparency, snow and specks of the wet film were rated from 0 to 5 by transmitted light inspection (0=very good dispersion quality, i.e. film is completely transparent, no specks, no snow; 5=very poor film dispersion quality, film is milky and/or has lots of specks/snow).

Test B: The aqueous two-component polyurethane dispersion knife coated onto the glass sheet was cured for 30 minutes at 130° C. Film appearance was rated from 0 to 5 (0=very good film appearance, i.e. film is completely transparent, no specks, no snow; 5=very poor film appearance, film has lots of specks/snow).

Test C: Determination of particle size distribution by ultracentrifuge, as described in H. G. Müller, Colloid Polym. Sci. 267 (1989), pages 1113-1116. Frequency distribution values d₁₀, d₅₀ and d₉₀ are used.

### Example 2: (Comparative Example)

A test arrangement was used for this purpose which differed as follows from the apparatus according to the invention or from the process according to the invention in the exemplary embodiments: the metering pumps 3 and 4, which took the form of gear pumps, and the mixer 5 were used in the same arrangement as in the Examples according to the invention. However, the pre-emulsion was subjected to the tests A, B and C described in Example 1 without further homogenisation in a jet disperser.

### Example 3: (Comparative Example)

A test arrangement was used for this purpose which differed as follows from the apparatus according to the invention or from the process according to the invention in the exemplary embodiments: the metering pumps 3 and 4, which took the form of gear pumps, and the mixer 5 were used in the same arrangement as in the Examples according to the invention. The pre-emulsion was, however, supplied with the pump 6 (c.f. FIG. 1) for homogenisation to an adjustable jet disperser with a 10×0.1 mm slot, as described in FIG. 1 in DE 199 33 440. There was no return line 8 as described in FIG. 1. The coating emulsion produced in this manner was investigated in accordance with the tests A, B and C described in Example 1.

Table 1 shows the test parameters and results for the exemplary embodiments and Comparative Examples.

TABLE 1

| | Ex. 1 | Ex. 1 | Ex. 1 | Ex. 2 | Ex. 3 | Ex. 3 |
|---|---|---|---|---|---|---|
| | Test 1 | Test 2 | Test 3 | Test 4 | Test 5 | Test 6 |
| Throughput [g/min] | 200 | 400 | 800 | 400 | 200 | 800 |
| Pressure, pump 3 [bar] | 1.4 | 5 | 18 | 5.4 | 1.8 | 13 |
| Pressure, pump 4 [bar] | <0.2 | 1.1 | 6.6 | 1.8 | 0.2 | 4 |
| Pressure drop over | 7 | 8 | 10 | — | 10 | 11 |
| nozzle 7 or slot | | | | | | |
| nozzle [bar] | | | | | | |
| Test A | 1 | 1 | 1 | 5 | 5 | 2 |
| Test B | 0 | 0 | 0 | 5 | 4 | 1 |
| Test C | 0.0545 | 0.0531 | 0.0774 | 0.0434 | 0.0541 | 0.0596 |
| d₁₀ [μm] | | | | | | |
| Test C | 0.1063 | 0.0950 | 0.2479 | 0.0740 | 0.0968 | 0.1144 |
| d₅₀ [μm] | | | | | | |
| Test C | 1.5409 | 1.6811 | 1.5468 | 8.7979 | 6.3565 | 2.2777 |
| d₉₀ [μm] | | | | | | |

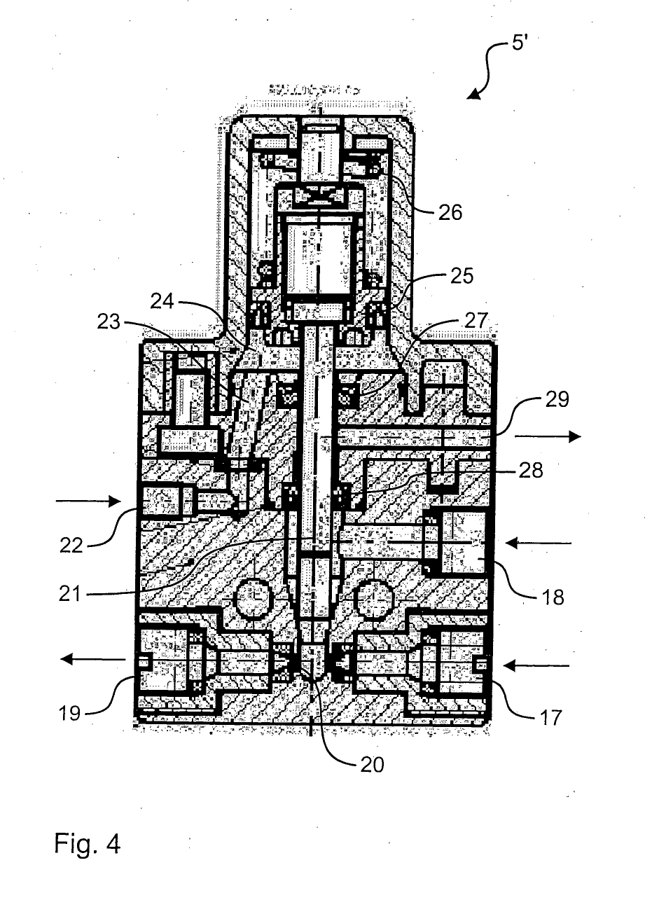

The cross-sectional view in FIG. 4 shows an alternative exemplary embodiment of a mixer 5′, which can be used in the arrangement according to FIG. 1, in order to produce a pre-emulsion from the aqueous binder dispersion 1 and the polyisocyanate 2.

The polyisocyanate 2 here acts as curing agent and is supplied to the mixer 5′ via a connection 17, while the aqueous binder dispersion 1 is supplied to the mixer 5′ via another connection 18.

In order to discharge the pre-emulsion 9, the mixer 5′ has a connection 19, which is opposite the connection 17 and is arranged coaxially relative to the connection 17.

The connection 17 for the polyisocyanate 2 is connected via a through flow channel with the connection 19 for the pre-emulsion 9, there being, in the flow channel between the connection 17 and the connection 19, a nozzle-like narrow point 20 in order to increase the pressure in the flow channel. The narrow point 20 is here arranged in an exchangeable nozzle body, such that different cross-sections may be obtained in the narrow point 20 by exchanging the nozzle body. Supply of the binder dispersion 1 is here controlled by a valve needle 21 which is displaceably mounted in a valve bore and, depending on its position, allows or blocks access to the flow channel between connections 17 and 19. In the position of the valve needle 21 shown in FIG. 4, access from the connection 18 to the flow channel is blocked, such that no binder dispersion 1 is mixed into the polyisocyanate 2.

The valve needle 21 may here be raised pneumatically in order to mix the polyisocyanate 2 into the binder dispersion 1. To this end, the mixer 5′ has a connection 22, to which a control air line may be connected. In the mixer 5′, the connection 22 is connected via a flow channel 23 with a pressure chamber 24, wherein the pressure prevailing in the pressure chamber 24 acts upon a piston 25, which is provided on top of the valve needle 21. A spiral spring 26 is furthermore provided, which is supported against the top of the mixer 5′ and presses the valve needle 21 axially downwards in the direction of the narrow point 20. When the pressure in pressure chamber 24 increases, the valve needle 21 is accordingly forced upwards against the spring force of the spiral spring 26 until the valve seat between connection 18 and connection 19 is opened.

In this raised position of the valve needle 21, the binder dispersion 1 can penetrate from the connection 18 into the flow channel between connection 17 and connection 19 and mix with the polyisocyanate 2.

The mixer 5′ furthermore comprises two sealing rings 27, 28 which seal the guide bore of the valve needle 21 in order to prevent the binder dispersion 1 supplied via the connection 18 from penetrating upwards along the guide bore of the valve needle 21.

The mixer 5′ moreover comprises a leakage bore 29, through which it is possible to discharge any binder dispersion 1 which, in the event of failure of the lower sealing ring 28, has penetrated upwards along the guide bore of the valve needle 21.

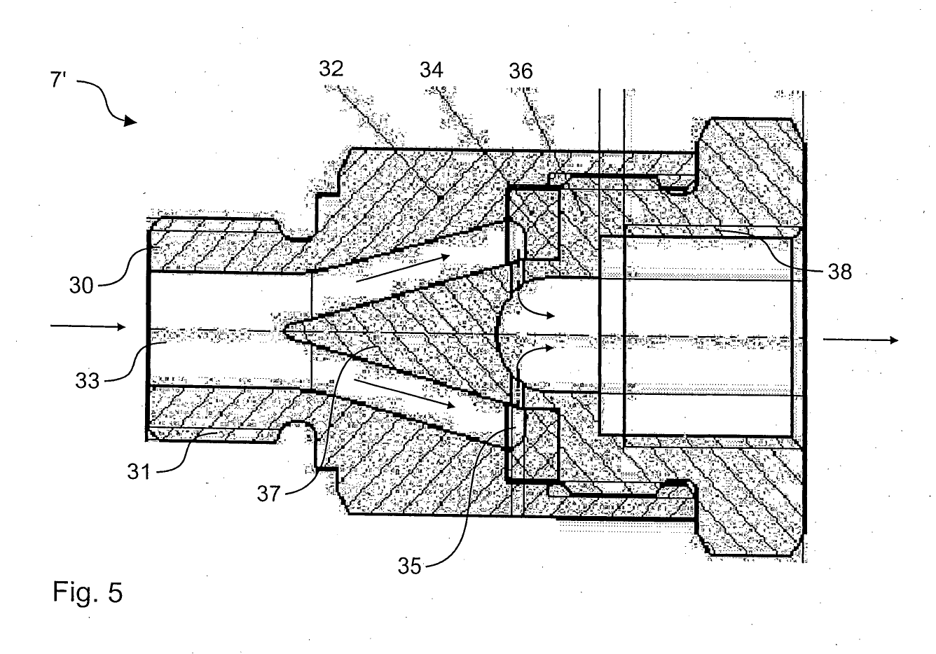

An alternative embodiment of the homogeniser 7′, from which the finished coating emulsion is produced from the pre-emulsion 9 produced by the mixer 5′, will now be described below with the assistance of the cross-sectional view in FIG. 5. On the inlet side, the homogeniser 7′ has a screw flange 30 with an external thread 31 for connection with the pump 6, wherein a tube flange of a corresponding feed line may be screwed onto the external thread 31.

The screw flange 30 is formed on a nozzle body 32, wherein there passes through the nozzle body 32 a flow channel 33 which flares out conically.

An annular nozzle plate 34 is inserted in the nozzle body 32, said nozzle plate having on its side facing towards the screw flange 30 mutually opposing radial bores 35 which modify the direction of flow of the pre-emulsion flowing in the flow channel 33.

A further nozzle body 36 is furthermore screwed into the nozzle body 32, said nozzle body 36 fixing the nozzle plate 34 in the nozzle body 32 and, with a conical protrusion 37 formed thereon, projecting axially through the nozzle plate 34 into the conically flaring portion of the flow channel 33, wherein the radial bores 35 continue inwards into the projection 37.

In this exemplary embodiment, the radial bores 35 are arranged in the zone of the conically tapering protrusion 37. It is, however, alternatively also possible for the radial bores 35 to be located in the cylindrical zone of the nozzle body 36. On the outlet side, the nozzle body 36 has an internal thread 38, into which a corresponding connection flange of a feed line may be screwed.

In operation, the pre-emulsion in the flow channel 33 is thus forced through the radial bores 35 in the nozzle plate 34 and so homogenised.

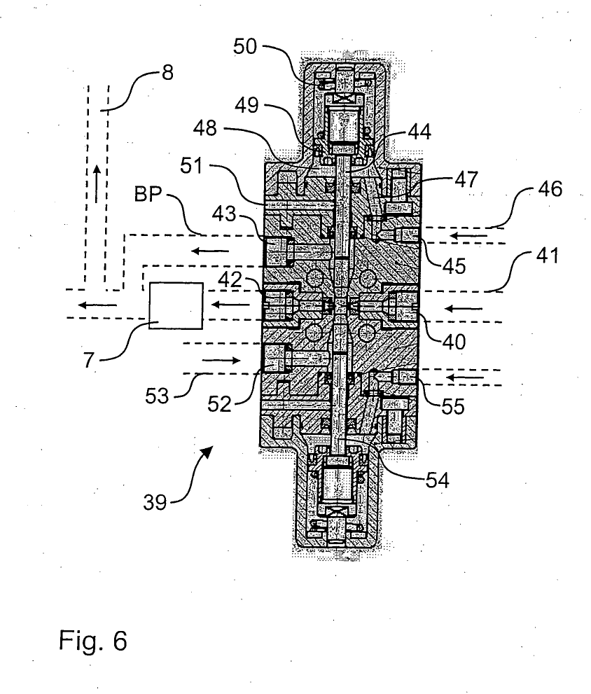

A variant of the apparatus according to the invention shown in FIG. 1, in which there is provided a bypass line BP, which allows the homogeniser 7 to be bypassed during rinsing operation, will now be described below with the assistance of the cross-sectional view in FIG. 6. Such bypassing of the homogeniser 7 during rinsing operation advantageously prevents the flow resistance of the homogeniser 7 from reducing the pressure of the rinsing agent downstream from the homogeniser 7.

In order to avoid repetition, reference is largely made to the above description relating to FIG. 1, the same reference numerals being used for corresponding components, but just with the addition of an apostrophe in order to avoid repetition.

Upstream from the homogeniser 7, there is arranged a valve unit 39, the valve unit 39 being in part a similar structure to the mixer 5′ shown in FIG. 4. The valve unit 39 is accordingly described by complementary reference to the description relating to FIG. 4.

On the inlet side, the valve unit 39 has a connection 40, which may be connected via a feed line 41 with the mixer 5′, in order to receive the pre-emulsion 9. On the outlet side, the valve unit 39 has a further connection 42, which is connected with the homogeniser 7, the homogeniser 7 possibly being constructed, for example, in accordance with FIG. 3 or 5.

The bypass line BP extends from a connection 43 of the valve unit 39 and opens into a zone downstream from the homogeniser 7, the connection 43 being connected with a guide bore of a valve needle 44. During rinsing operation, rinsing agent may accordingly be passed by the homogeniser 7 via the bypass line BP. To this end, the valve needle 44 is raised, as will be described in detail below. A through flow channel, which comprises a narrow point centrally between the connection 40 and the connection 42, runs between the inlet-side connection 40 and the outlet-side connection 42 of the valve unit 39.

The position of the valve needle 44 is here controlled by a further connection 45, to which a control air line 46 is connected, the connection 45 opening via a flow channel 47 into a pressure chamber 48. The pressure prevailing in the pressure chamber 48 acts upon a piston 49, which is fastened on top of the valve needle 44 and is displaceable in the head of the valve unit 39, the piston 49 being downwardly pretensioned by a spiral spring 50. By increasing the pressure in the pressure chamber 48, the valve needle 44 may thus be raised axially upwards out of the position shown in FIG. 6, such that the narrow point of the flow channel between the connection 40 and the connection 42 is opened upwards. The valve needle 44 is here mounted displaceably in a guide bore, the annular gap between the valve needle 44 and the internal wall of the guide bore being sealed by two sealing rings, as has already been explained above in connection with the description relating to FIG. 5. The valve unit 39 furthermore comprises a leakage bore 51 which, in the event of failure of the lower sealing ring, permits discharge of the coating emulsion supplied via the return line BP.

In its lower part, the valve unit 39 has a connection 52, which is connected with a blast air line 53 so that the valve unit 39 can, if necessary, be blown clear with air. The blast air is here in turn controlled by a valve needle 54, which can be pneumatically actuated by another connection 55. The valve needle 54 is here actuated via the connection 55 in the same manner as in the upper part of the valve unit 39 so, to avoid repetition, reference is made in this regard to the above description.

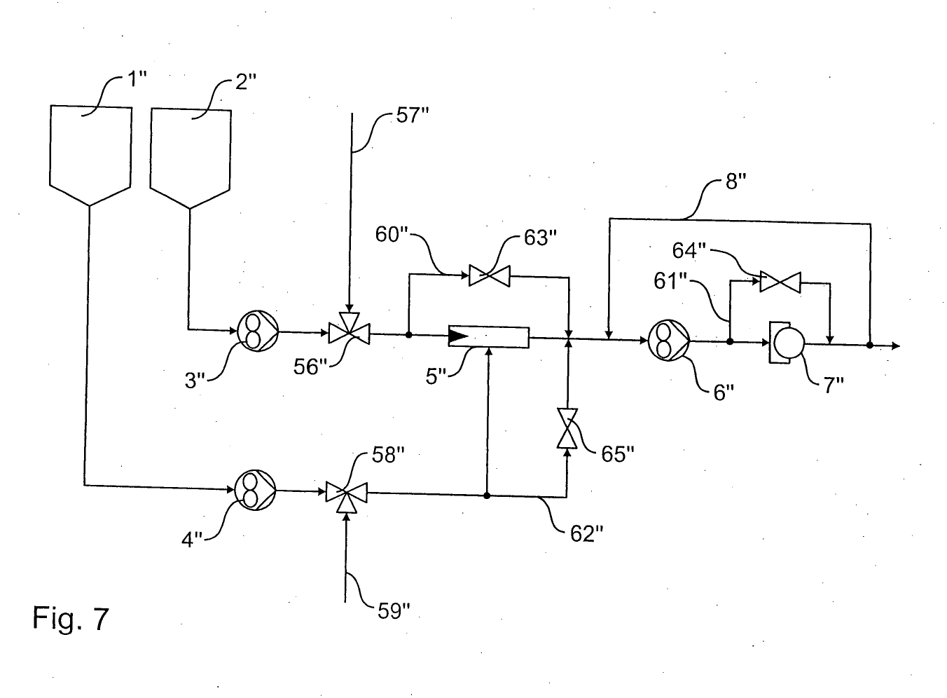

FIG. 7 shows an arrangement for the production of an aqueous two-component polyurethane coating emulsion from an aqueous binder dispersion comprising isocyanate-reactive hydrogen atoms and a polyisocyanate, said arrangement largely corresponding to the arrangement described above and shown in FIG. 1. In order to avoid repetition, only the special features of this arrangement will thus be described, while reference is otherwise made to the above description relating to FIG. 1. Furthermore, the same reference numerals as in FIG. 1 are used below for corresponding components, but with the addition of two apostrophes for the purpose of differentiation.

One special feature of this arrangement is the possibility of rinsing in order to remove residues of the binder dispersion 1″, the polyisocyanate 2″, the pre-emulsion or the finished coating emulsion from the arrangement. To this end, a three-way valve 56″ is arranged between the metering pump 3″ and the mixer 5″, which valve connects the mixer 5″ with the metering pump 3″ during coating operation and with a rinsing agent line 57″ during rinsing operation. A three-way valve 58″ is also arranged between the metering pump 4″ and the mixer 5″, which valve connects the mixer 5″ with the metering pump 4″ during coating operation and with a rinsing agent line 59″ during rinsing operation. During rinsing operation, the flow resistance of the mixer 5″ and of the homogeniser 7″ normally results in a reduction in rinsing agent pressure downstream from the mixer 5″ and the homogeniser 7″. In order to avoid this disadvantage, bypass lines 60″, 61″, 62″ are accordingly provided in this arrangement, which make it possible to bypass the mixer 5″ and the homogeniser 7″, so that adequate rinsing agent pressure can also be achieved downstream from the mixer 5″ and the homogeniser 7″.

In order either to open or to block the bypass lines 60″, 61″ and 62″, a controllable valve 63″, 64″ or 65″ is arranged in each bypass line 60″, 61″, 62″.

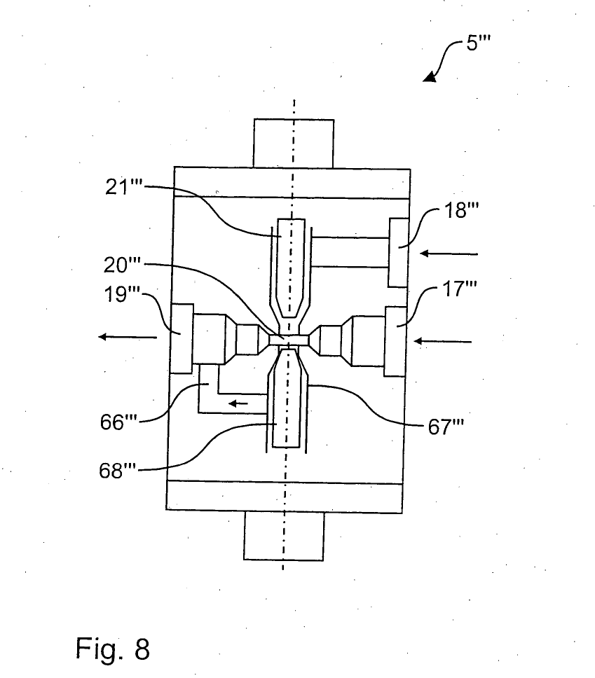

FIG. 8 finally shows an alternative embodiment of a mixer 5′″, the mixer 5′″ largely corresponding to the mixer 5′ shown in FIG. 4, such that only the special features of the mixer 5′″ are described below and, in order to avoid repetition, reference is otherwise made to the description relating to FIG. 4. Furthermore, the same reference numerals as in FIG. 4 are used below for corresponding components, but with the addition of three apostrophes for the purpose of differentiation.

One special feature of the mixer 5′″ is its good rinsability, which is not impaired by the narrow point 20′″.

To this end, the mixer 5′″ has a bypass line 66′″, which connects the outlet side connection 19′″ with a guide bore 67′″ of a further valve needle 68′″, the guide bore 67′″ opening into the narrow point 20′″. For rinsing, the valve needle 21′″ is accordingly moved upwards, while the valve needle 68′″ is moved downwards. Rinsing agent is then supplied via the connection 18′″, which passes via the guide bore of the valve needle 21′″ through the narrow point 20′″ into the guide bore 67′″ and then passes via the bypass line 66′″ to the connection 19′″. The bypass line 66′″ thus allows the narrow point 20′″ to be bypassed during rinsing operation, such that the rinsing agent pressure downstream from the mixer 5′″ is not influenced by the flow resistance of the narrow point 20′″.

The invention is not limited to the above-described preferred exemplary embodiments. Instead, many variants and modifications are possible, which also make use of the concept of the invention and thus fall within the scope of protection.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a two-component coating mixture having the following steps:
mixing of a first coating component and a second coating component in a mixer to yield the two-component coating mixture, and
homogenizing the two-component coating mixture using a homogeniser, wherein at least a portion of the two-component coating mixture is homogenised repeatedly in succession in the homogeniser.

2. The process according to claim 1, wherein the two coating components are supplied to the mixer separately from one another at a pressure of at most 2.5 MPa.

3. The process according to claim 1, wherein a portion of the two-component coating mixture from an outlet of the homogeniser is recirculated to an inlet of the homogeniser.

4. The process according to claim 1, wherein a first coating component is an aqueous binder dispersion comprising isocyanate-reactive hydrogen atoms, and a second coating component contains polyisocyanate.

5. The process according to claim 1, wherein, between the mixer and the homogeniser, the two-component coating mixture exhibits a mass flow rate of from 50 g/minute to 3000 g/minute.

6. The process according to claim 1, wherein the homogeniser is a jet disperser.

7. The process according to claim 1, wherein
a first coating component is supplied to the mixer by a first pump, and/or
a second coating component is supplied to the mixer by a second pump, and/or
the two-component coating mixture is delivered by a third pump from the mixer to the homogeniser.

8. The process according to claim 7, wherein the third pump is operated at a higher delivery capacity than the first pump and the second pump together.

9. The process according to claim 7, wherein at least one of the first pump, the second pump and the third pump is a gear pump.

10. An apparatus for the production of a two-component coating mixture, comprising
a mixer for the production of the two-component coating mixture capable of mixing a first coating component and a second coating component, and
a homogeniser capable of homogenizing the two-component coating mixture, the homogeniser being arranged downstream from the mixer,
wherein
a return line, which branches off in an output zone of the homogeniser and opens into an input zone of the homogeniser, in order to recirculate a portion of the two-component coating mixture homogenised by the homogeniser for rehomogenisation.

11. The apparatus according to claim 10, wherein
a first pump for delivering the first coating component, the first pump being connected via a first feed line with the mixer, and
a second pump for delivering the second coating component, the second pump being connected via a second feed line with the mixer, and
a third pump for delivering the two-component coating mixture, the third pump being arranged between the mixer and the homogeniser.

12. The apparatus according to claim 11, wherein the third pump has a greater delivery capacity than the first pump and/or the second pump.

13. The apparatus according to claim 11, wherein the first pump and/or the second pump and/or the third pump has a delivery pressure which amounts to at most 2.5 MPa.

14. The apparatus according to claim 11, wherein the first pump and/or the second pump and/or the third pump is a gear pump.

15. The apparatus according to claim 11, wherein a filter is arranged in the first feed line and/or in the second feed line and/or in the third feed line upstream from the mixer.

16. The apparatus according to claim 10, wherein the homogeniser is a jet disperser.

17. The apparatus according to claim 10, wherein the first coating component is an aqueous binder dispersion comprising isocyanate-reactive hydrogen atoms, and the second coating component contains polyisocyanate.

18. The apparatus according to claim 11, wherein the return line opens into a zone between the mixer and the third pump.

19. The apparatus according to claim 10, wherein the mixer and/or the homogeniser comprises a rinsing agent connection.

20. The apparatus according to claim 10, wherein the mixer comprises a controllable valve which controls a feed stream of the first coating component and/or a feed stream of the second coating component and/or a discharge of the two-component coating mixture.

21. The apparatus according to claim 10, wherein at least one bypass line is provided in order to bypass the mixer and/or the homogeniser during rinsing operation.

22. The apparatus according to claim 21, wherein a controllable valve is arranged in the bypass line.

23. A substrate coated with a coating layer comprising the two-component coating mixture provided by the process according to claim 1.

24. The process according to claim 1, wherein the two-component coating mixture includes an aqueous binder dispersion comprising isocyanate-reactive hydrogen atoms and a polyisocyanate and forms an aqueous polyurethane coating emulsion.

25. The process according to claim 2, wherein a portion of the two-component coating mixture from an outlet of the homogeniser is recirculated to an inlet of the homogeniser.

26. The process according to claim 8, wherein at least one of the first pump, the second pump and the third pump is a gear pump.

27. The apparatus according to claim 10, wherein the two-component coating mixture includes an aqueous binder dispersion comprising isocyanate-reactive hydrogen atoms and a polyisocyanate, and forms an aqueous two-component polyurethane coating emulsion.

28. The apparatus according to claim 12, wherein the first pump and/or the second pump and/or the third pump has a delivery pressure which amounts to at most 2.5 MPa.

29. The apparatus according to claim 12, wherein the first pump and/or the second pump and/or the third pump is a gear pump.

30. The apparatus according to claim 13, wherein the first pump and/or the second pump and/or the third pump is a gear pump.

31. The apparatus according to claim 28, wherein the first pump and/or the second pump and/or the third pump is a gear pump.

32. The apparatus according to claim 12, wherein a filter is arranged in the first feed line and/or in the second feed line and/or in the third feed line upstream from the mixer.

33. The apparatus according to claim 13, wherein a filter is arranged in the first feed line and/or in the second feed line and/or in the third feed line upstream from the mixer.

34. The apparatus according to claim 14, wherein a filter is arranged in the first feed line and/or in the second feed line and/or in the third feed line upstream from the mixer.

35. The apparatus according to claim 11, wherein the homogeniser is a jet disperser.

36. The apparatus according to claim 12, wherein the homogeniser is a jet disperser.

37. The apparatus according to claim 13, wherein the homogeniser is a jet disperser.

38. The apparatus according to claim 14, wherein the homogeniser is a jet disperser.

39. The apparatus according to claim 15, wherein the homogeniser is a jet disperser.

40. The apparatus according to claim 11, wherein the first coating component is an aqueous binder dispersion comprising isocyanate-reactive hydrogen atoms, and the second coating component contains polyisocyanate.

41. The apparatus according to claim 12, wherein the first coating component is an aqueous binder dispersion comprising isocyanate-reactive hydrogen atoms, and the second coating component contains polyisocyanate.

42. The apparatus according to claim 13, wherein the first coating component is an aqueous binder dispersion comprising isocyanate-reactive hydrogen atoms, and the second coating component contains polyisocyanate.

43. The apparatus according to claim 14, wherein the first coating component is an aqueous binder dispersion comprising isocyanate-reactive hydrogen atoms, and the second coating component contains polyisocyanate.

44. The apparatus according to claim 15, wherein the first coating component is an aqueous binder dispersion comprising isocyanate-reactive hydrogen atoms, and the second coating component contains polyisocyanate.

45. The apparatus according to claim 16, wherein the first coating component is an aqueous binder dispersion comprising isocyanate-reactive hydrogen atoms, and the second coating component contains polyisocyanate.

46. The apparatus according to claim 12, wherein the return line opens into a zone between the mixer and the third pump.

47. The apparatus according to claim 13, wherein the return line opens into a zone between the mixer and the third pump.

48. The apparatus according to claim 14, wherein the return line opens into a zone between the mixer and the third pump.

49. The apparatus according to claim 15, wherein the return line opens into a zone between the mixer and the third pump.

50. The apparatus according to claim 16, wherein the return line opens into a zone between the mixer and the third pump.

51. The apparatus according to claim 17, wherein the return line opens into a zone between the mixer and the third pump.

52. The apparatus according to claim 11, wherein the mixer and/or the homogeniser comprises a rinsing agent connection.

53. The apparatus according to claim 12, wherein the mixer and/or the homogeniser comprises a rinsing agent connection.

54. The apparatus according to claim 13, wherein the mixer and/or the homogeniser comprises a rinsing agent connection.

55. The apparatus according to claim 14, wherein the mixer and/or the homogeniser comprises a rinsing agent connection.

56. The apparatus according to claim 15, wherein the mixer and/or the homogeniser comprises a rinsing agent connection.

57. The apparatus according to claim 16, wherein the mixer and/or the homogeniser comprises a rinsing agent connection.

58. The apparatus according to claim 17, wherein the mixer and/or the homogeniser comprises a rinsing agent connection.

59. The apparatus according to claim 18, wherein the mixer and/or the homogeniser comprises a rinsing agent connection.

60. A substrate coated with a coating layer comprising the two-component coating mixture provided by the process according to claim 2.

61. A substrate coated with a coating layer comprising the two-component coating mixture provided by the process according to claim 3.

62. A substrate coated with a coating layer comprising the two-component coating mixture provided by the process according to claim 4.

63. A substrate coated with a coating layer comprising the two-component coating mixture provided by the process according to claim 5.

64. A substrate coated with a coating layer comprising the two-component coating mixture provided by the process according to claim 6.

65. A substrate coated with a coating layer comprising the two-component coating mixture provided by the process according to claim 7.

66. A substrate coated with a coating layer comprising the two-component coating mixture provided by the process according to claim 8.

67. A substrate coated with a coating layer comprising the two-component coating mixture provided by the process according to claim 9.
